(19) United States
(12) Patent Application Publication
(10) Pub. No.: US 2023/0174041 A1
(43) Pub. Date: Jun. 8, 2023

(54) EVALUATING AND MANAGING SUPERCAPACITORS OF ELECTRIC VEHICLES

(71) Applicant: SUSTAINABLE ENERGY TECHNOLOGIES, INC., WILMINGTON, DE (US)

(72) Inventor: John Cronin, WILMINGTON, DE (US)

(21) Appl. No.: 18/076,255

(22) Filed: Dec. 6, 2022

Related U.S. Application Data
(60) Provisional application No. 63/286,396, filed on Dec. 6, 2021.

(51) Int. Cl. B60W 10/26; B60L 50/40; G01C 21/00

(52) U.S. Cl. CPC B60W 10/26; B60L 50/40; G01C 21/3837; B60W 2510/242

(57) ABSTRACT

A system for evaluating and controlling an electric vehicle including one or more supercapacitors includes a status IO control module configured to poll a plurality of modules of the electric vehicle for information, each module controlling one or more of energy optimization, charging, maintenance, speed optimization, control, communications, health and safety, security and motor control of the electric vehicle; and store information received from the polling of the plurality of modules in a status IO database within the electric vehicle; and a mobile device configured to access the status IO database via a communication interface and use the stored information in the status IO database to directly control the electric vehicle.

### CROSS-REFERENCE TO RELATED APPLICATIONS

This application claims the benefit of U.S. Provisional Application No. 63/286,396, filed Dec. 6, 2021, for “EVALUATING AND MANAGING SUPERCAPACITORS OF ELECTRIC VEHICLES,” the disclosure of which is incorporated herein by reference in its entirety.

### FIELD OF THE DISCLOSURE

The present disclosure is generally related to electric vehicles and, more specifically, to mobile devices to evaluate and control electric vehicles.

### BACKGROUND

Electric vehicles using supercapacitors do not easily allow users to evaluate or control the electric vehicle's energy optimization, charging, maintenance, speed optimization, control, communications, health and safety, security, and motor control. The information required to control these aspects of the electric vehicle come from many sources and needs to be better managed.

There are many mobile device types, supercapacitor types in electric vehicles, and many data sources to evaluate and manage energy optimization, charging, maintenance, speed optimization, control, communications, health and safety, security, and motor control.

The following embodiments provide for evaluating and managing many mobile device types, supercapacitor types in electric vehicles, and many sources of data to evaluate and manage energy optimization, charging, maintenance, speed optimization, control, communications, health and safety, security and motor control.

### SUMMARY OF THE DISCLOSURE

According to one aspect, a system for evaluating and controlling an electric vehicle including one or more supercapacitors includes a status IO control module configured to poll a plurality of modules of the electric vehicle for information, each module controlling one or more of energy optimization, charging, maintenance, speed optimization, control, communications, health and safety, security and motor control of the electric vehicle, and store information received from the polling of the plurality of modules in a status IO database within the electric vehicle. The system also includes a mobile device configured to access the status IO database via a communication interface and use the stored information in the status IO database to directly control the electric vehicle. In some embodiments, the plurality of modules are sub-modules of a base module within memory unit of the electric vehicle.

In one embodiment, the system also includes an energy management database accessible via an energy management network and a mobile device database within the mobile device. In such an embodiment, the status IO control module may be further configured to synchronize the status IO database, the energy management database, and the mobile device database. The energy management database may be configured to provide historical data related to the electric vehicle. For example, the energy management database may store one or more of information related to supercapacitors, electric charge percentage, acceleration of an electric motor, data for individual drivers, driving conditions, power pack identity or characteristics, mass of the electric vehicle including passengers and cargo. The energy management database, mobile device database, and status IO database have a similar structure. For example, the energy management database, mobile device database, and status IO database each store data received from the plurality of modules of the electric vehicle regarding one or more of energy optimization, charging, maintenance, speed optimization, control, communications, health and safety, security and motor control of the electric vehicle.

Further, the mobile device may be configured to evaluate or control the electric vehicle directly after synchronization of the status IO database, the energy management database, and the mobile device database. In some embodiments, the mobile device is configured to control the one or more supercapacitors.

In some embodiments, the system may include mobile device base module configured to poll for data from the communication interface. If data is available, the mobile device base module may read from the communication interface a status of the electric vehicle and the one or more supercapacitors via the status IO control module and store any data received in a mobile device database within the mobile device. The mobile device base module may also be configured to synchronize the energy management database with the mobile device database.

In one embodiment, the status IO control module connects to the one or more supercapacitors via a status hardware controller. The mobile device may connect with the status IO control module via the communication interface and the status hardware controller.

The status hardware controller may be configured to poll the status IO control module and, if data is available from the one or more supercapacitors, read the data from the one or more supercapacitors and sending the data to the status IO control module. In one embodiment, the status hardware controller is further configured to, if data is to be sent to or received from the communication interface, send data to the communication interface or receive data from the communication interface. In some embodiments, the status hardware controller is further configured to poll for data from a mobile communication interface of the mobile device, and, if data from the mobile communication interface is available to send or receive to the one or more supercapacitors, send the data to the one or more supercapacitors or receive the data from the one or more supercapacitors.

In some embodiments, the system further comprises a geographic module configured to geolocate the electric vehicle and evaluate one or more of past route data and future route data. The geographic module may be further configured to initiate a mapping system that integrate with data received from electric vehicle to display data related to a future route. In some embodiments, the geographic module is further configured to use present, past, and future route data to calculate changes on data for the electric vehicle and display the changes on a display device.

### BRIEF DESCRIPTIONS OF THE DRAWINGS

The accompanying drawings illustrate various embodiments of systems, methods, and various other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A is a schematic diagram of an energy storage unit (ESU) and an energy control system (ECS), according to an embodiment.

FIG. 1B is a schematic diagram of a modular power pack system for an electric vehicle, according to an embodiment.

FIG. 2 is a flowchart of a method performed by a status IO control module, according to an embodiment.

FIG. 3 is a flowchart of a method performed by a status hardware controller, according to an embodiment.

FIG. 4 is a flowchart of a method performed by a mobile device base module, according to an embodiment.

FIG. 5 is a flowchart of a method performed by a geographic, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the claims' spirit or scope. Additionally, well-known elements of exemplary embodiments of the invention will not be described in detail or will be omitted so as not to obscure the relevant details of the invention

As used herein, the word exemplary means serving as an example, instance, or illustration. The embodiments described herein are not limiting but rather are exemplary only. It should be understood that the described embodiments are not necessarily to be construed as preferred or advantageous over other embodiments. Moreover, the terms embodiments of the invention, embodiments, or invention do not require that all embodiments include the discussed feature, advantage, or mode of operation.

Further, many of the embodiments described herein are described in sequences of actions to be performed by, for example, elements of a computing device. It should be recognized by those skilled in the art that specific circuits can perform the various sequence of actions described herein (e.g., application-specific integrated circuits or “ASICs”) and/or by program instructions executed by at least one processor. Additionally, the sequence of actions described herein can be embodied entirely within any form of computer-readable storage medium. The execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of the terminology used herein is provided.

### Energy Storage Unit (ESU)

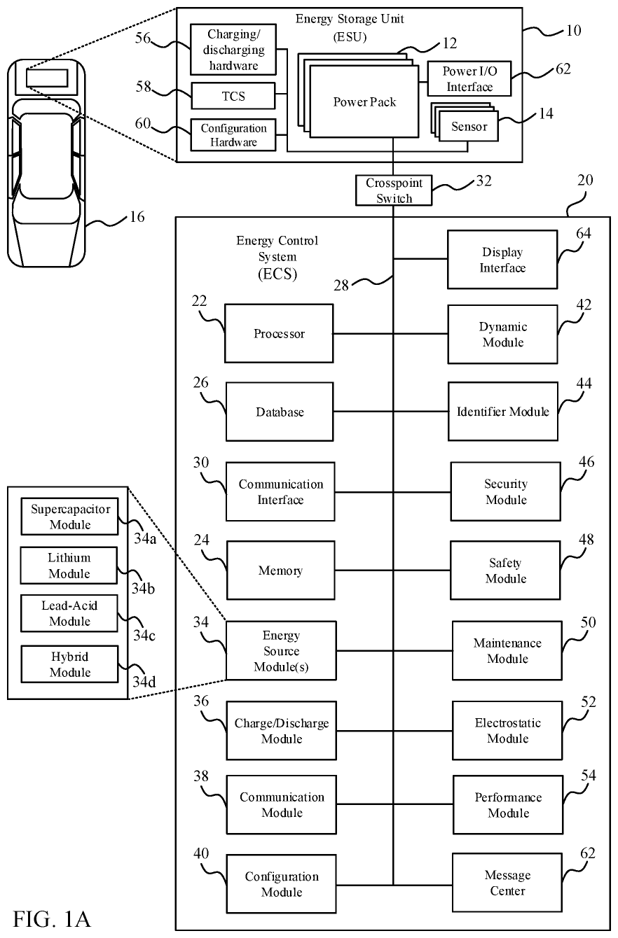

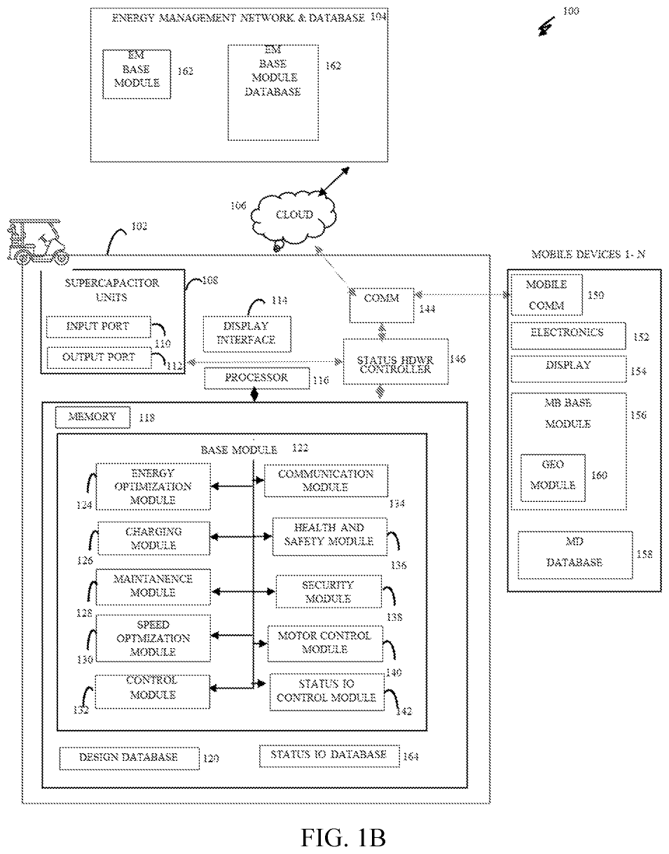

FIG. 1A illustrates an energy storage unit (ESU) 10 for supercapacitors according to one embodiment. As used herein, a supercapacitor may also be an ultracapacitor, which is an electrical component capable of holding hundreds of times more electrical charge than a standard capacitor. This characteristic makes ultracapacitors useful in devices that require relatively little current and low voltage. In some situations, an ultracapacitor can take the place of a rechargeable low-voltage electrochemical battery.

Ultracapacitors or supercapacitors typically have high power density meaning they can charge up quickly, but they also discharge quickly as well. The load curve of a chemical battery typically shows a high energy density, meaning that, on discharge, it is very stable (i.e., the voltage doesn't change much over time for a given load) for long periods of time. This means that the chemical battery (lead-acid or lithium-ion, etc.) has a high energy density but low power density. In other words, they charge slowly. Ultracapacitors or supercapacitors have been developed recently that have both a high power density (charge fast) and a high energy density (discharge slowly). Ideally, an ultracapacitor or supercapacitor has both a high power density and a high energy density, with a load discharge curve that resembles or comes close to a load discharge curve of a chemical battery. Hereafter, the term supercapacitor will be used generically to mean all forms of supercapacitors, but ideally has both high power density as well as high energy density.

The illustrated ESU 10 is a device that can store and deliver charge. It may include one or more power packs 12 which, in turn, may include supercapacitors. The ESU 10 may also include batteries, hybrid systems, fuel cells, etc. Capacitance provided in the components of the ESU 10 may be in the form of electrostatic capacitance, pseudocapacitance, electrolytic capacitance, electronic double layer capacitance, and electrochemical capacitance, and a combination thereof, such as both electrostatic double-layer capacitance and electrochemical pseudocapacitance, as may occur in supercapacitors. The ESU 10 may be associated with or include control hardware and software with suitable sensors 14, as needed, in order for an energy control system (ECS) 20 to manage any of the following: temperature control, discharging of the ESU 10 (whether collectively or of any of its components), charging of the ESU 10 (whether collectively or of any of its individual components), maintenance, interaction with batteries, battery emulation, communication with other devices, including devices that are directly connected, adjacent, or remote such as by wireless communication, etc. In some aspects, the ESU 10 may be portable and may be provided in a casing that also contains at least some components of the energy control system (ECS) 20 as well as various features, such as communication systems, a display interface, etc. The ESU 10 may be housed within, and provide power to, a device 16, such as an electric vehicle (EV).

### Energy Control System (ECS)

The ECS 20 is the combination of hardware and software that manages various aspects of the ESU 10 including the energy delivered by it to one or more devices. The ECS 20 regulates the ESU 10 to control discharging, charging, and other features as desired such as temperature, safety, efficiency, etc. The ESU 10 may be adapted to give the ECS 20 individual control over each power pack or optionally over each supercapacitor or grouped supercapacitor unit in order to efficiently tap the available power of individual supercapacitors and to properly charge individual supercapacitors rather than merely providing a single level of charge for the ESU 10 as a whole that may be too little or too much for individual supercapacitors or their power packs.

The ECS 20 may include or be operatively associated with a processor 22, a memory 24 comprising code for the controller, a database 26, a bus 28, and one or more communication interfaces 30, such as a wireless interface, for interacting with other units or otherwise providing information, information requests, or commands. The ECS 20 may interact with individual power packs 12 or supercapacitors through a crosspoint switch 32 or other matrix systems. Further, the ECS 20 may obtain information from individual power packs 12 or their supercapacitors through similar switching mechanisms or direct wiring in which, for example, one or more of a voltage detection circuit, an amperage detection circuit, a temperature sensor, and other sensors or devices may be used to provide details on the level of charge and performance of the individual power pack 12 or supercapacitor.

The ECS 20 may include one or more energy source modules 34, a charge/discharge module 36, a communication module 38, a configuration module 40, a dynamic module 42, an identifier module 44, a security module 46, a safety module 48, a maintenance module 50, an electrostatic module 52 and a performance module 54, etc. The ECS 20 may include one or more modules that can be executed or governed by the processor 22 according to code stored in a memory 24, such as a chip, a hard drive, a cloud-based source or other computer readable medium.

The ECS 20 may therefore manage any or all of the following: temperature control, discharging of the ESU 10 (whether collectively or of any of its components), charging of the ESU 10 (whether collectively or of any of its individual components), maintenance, interaction with batteries or battery emulation, and communication with other devices, including devices that are directly connected, adjacent, or remote, such as by wireless communication.

The ECS 20 may include one or more energy source modules 34 that govern specific types of energy storage devices, such as a supercapacitor module 34a for governing supercapacitors, a lithium module 34b for governing lithium batteries, a lead-acid module 34c for governing lead-acid batteries, and a hybrid module 34d for governing the combined cooperative use of a supercapacitor and a battery. Each of the energy storage modules 34 may include software encoding algorithms for control such as for discharge or charging or managing individual energy sources, and may include or be operationally associated with hardware for redistributing charge among the energy sources to improve efficiency of the ESU 10, for monitoring charge via charge measurement systems such as circuits for determining the charge state of the respective energy sources, etc., and may include or be operationally associated with devices for receiving and sending information to and from the ECS 20 or its other modules, etc. The energy source modules 34 may also cooperate with the charge/discharge module 36 responsible for guiding the charging of the overall ESU 10 to ensure a properly balanced charge, as well as the efficient discharging of the ESU 10 during use which may also seek to provide proper balance in the discharging of the energy sources.

The dynamic module 42 may be used for managing changing requirements in the power supplied. In some aspects, the dynamic module 42 includes anticipatory algorithms which seek to predict upcoming changes in power demand and to adjust the state of the ECS 20 in order to be ready to more effectively handle the change. For example, in one case, the ECS 20 may communicate with a GPS and/or terrain map (not shown) for the route being taken by the electric vehicle and recognize that a steep hill will soon be encountered. The ECS 20 may anticipate the need to increase torque and thus deliver electrical power from the ESU 10, and thus activate additional power packs 12 if only some are in use or otherwise increase the draw from the power packs 12 in order to handle the change in slope efficiently to achieve desired objectives such as maintaining speed, reducing the need to shift gears on a hill, or reducing the risk of stalling or other problems.

The communication module 38 and an associated configuration system may be used to properly configure the ECS 20 to communicate not only with the interface or other aspects of a vehicle, but also to communicate with central systems or other vehicles, when desired. In such cases, a fleet of vehicles may be effectively monitored and managed to improve energy efficiency and track performance of vehicles and their ESUs 10, thereby providing information that may assist with maintenance protocols, for example. Such communication may occur wirelessly or through the cloud via the communication interface 30, and may share information with various central databases, or access information from databases to assist with the operation of the vehicle and the optimization of the ESU 10, for which historical data may be available in a database.

Databases 26 of use with the ECS 20 include databases 26 on the charge and discharge behavior of the energy sources in the ESU 10 in order to optimize both charging and discharging in use based on known characteristics, databases 26 of topographical and other information for a route to be taken by the electric vehicle or an operation to be performed by another device employing the ESU 10, wherein the database 26 provides guidance on what power demands are to be expected in advance in order to support anticipatory power management wherein the status of energy sources and the available charge is prepared in time to deliver the needed power proactively. Charging databases 26 may also be of use in describing the characteristics of an external power source that will be used to charge the ESU 10. Knowledge of the characteristics of the external charge can be used to prepare for impedance matching or other measures needed to handle a new input source to charge the ESU 10, and with that data the external power can be received with reduced losses and reduced risk of damaging elements in the ESU 10 by overcharge, excessive ripple in the current, etc.

Beyond relying on static information in databases 26, in some aspects, the processor 22 is adapted to perform machine learning and to constantly learn from situations faced. In related aspects, the processor and the associated software form a “smart” controller based on machine learning or artificial intelligence adapted to handle a wide range of input and a wide range of operational demands.

In one embodiment, the ESU 10 is governed or controlled by the ECS 20, which is adapted to optimize at least one of charging, discharging, temperature management, safety, security, maintenance, and anticipatory power delivery. The ECS 20 may communicate with a display interface 64, to assist in control or monitoring of the ESU 10 and also may include a processor and a memory. The ECS 20 may interact with the hardware of the ESU 10, such as charging and discharging hardware 56, a temperature control system (TCS) 58, and configuration hardware 60, which not only provide data to the ECS 20 but also respond to directions from the ECS 20 for the management of the ESU 10.

### ESU Hardware

### Charging and Discharging Hardware

The charging and discharging hardware 56 may include the wiring, switches, charge detection circuits, current detection circuits, and other devices for proper control of charge applied to the power packs 12 or to the batteries or other ESUs 10, as well as temperature-control devices, such as active cooling equipment and other safety devices. Active cooling devices (not shown) may include fans, circulating heat transfer fluids that pass through tubing or in some cases surround or immerse the power pack, and thermoelectric cooling, such as Peltier effect coolers, etc.

In order to charge and discharge an individual power pack 12 to optimize the overall efficiency of the ESU 10, methods and devices are provided to select one or more of many power packs 12 from what may be a three-dimensional or two-dimensional array of connectors to the individual units. Any suitable methods and devices may be used for such operations, including the use of crosspoint switches 32 or other matrix switching tools. Crosspoint switches 32 and matrix switches are means of selectively connecting specific lines among many possibilities, such as an array of X lines (X1, X2, X3, etc.) and an array of Y lines (Y1, Y2, Y3, etc.) that may respectively have access to the negative or positive electrodes or terminals of the individual units among the power packs as well as the batteries or other energy storage units. Single-Pole Single-Throw (SPST) relays, for example, may be used. By applying charge to individual supercapacitors within power packs or to individual power packs within the ESU 10, charge can be applied directly to where it is needed and supercapacitor or power pack 12 can be charged to an optimum level independently of other power packs or supercapacitors. See “Understanding Tree and Crosspoint Matrix Architectures,” Pickering Test, https://www.pickeringtest.com/en-us/kb/hardware-topics/switching-architectures/understanding-tree-and-crosspoint-matrix-architectures, accessed Oct. 28, 2021.

Examples of crosspoint switches 32 and related components that may be adapted for one or more aspects of the disclosure herein, particularly the charging of supercapacitors or related power packs, are described in: “Digital Crosspoint Switches,” MicroSemi Corp. (Aliso Viejo, Calif.), https://www.microsemi.com/product-directory/signal-integrity/3579-digital-crosspoint-switches; “Micrel™ 2.5V/3.3V 3.0 GHz Dual 2×2 CML Crosspoint Switch w/Internal Termination, SuperLite™ SY55858U,” 2005, http://wwl.microchip.com/downloads/en/DeviceDoc/sy55858u.pdf; “Details, datasheet, quote on part number: BQ24640RVAR,” part of the BQ24640 family for “High Efficiency Synchronous Switch-Mode Battery Charge Controller for Supercapacitors,” Texas Instruments (Dallas, Tex.), https://www.digchip.com/datasheets/3258066-bq24640rvar.html; “8×8 Analog Crosspoint Switches Analog & Digital Crosspoint ICs,” Mouser Electronics (Mansfield, Tex.), https://www.mouser.com/c/semiconductors/communication-networking-ics/analog-digital-crosspoint-ics/; “200-MHz 16×16 Video Crosspoint Switch IC,” Analogue Dialogue, April 1997, https://www.analog.com/en/analog-dialogue/articles/200-mhz-16×16-video-crosspoint-switch-ic.html; “Crossbar Switch,” and Wikipedia, https://en.wikipedia.org/wiki/Crossbar_switch, accessed Oct. 28, 2021.

### Configuration Hardware

The configuration hardware 60 may include switches, wiring, and other devices to transform the electrical configuration of the power packs 12 between series and parallel configurations, such that a matrix of power packs may be configured to be in series, in parallel, or in some combination thereof. For example, as 12×6 array of power packs 12 may include four groups in series, with each group having 3×6 power packs in parallel. The configuration can be modified by a command from the configuration module 40, which then causes the configuration hardware 60 to make the change at an appropriate time (e.g., when the device is not in use).

### Sensors

The sensors 14 may include thermocouples, thermistors, or other devices associated with temperature measurement such as IR cameras, etc., as well as strain gauges, pressure gauges, load cells, accelerometers, inclinometers, velocimeters, chemical sensors, photoelectric cells, cameras, etc., that can measure the status of the power packs 12 or batteries or other ESUs 10, or other characteristics of the ESU 10 or the device, as described more fully hereafter. The sensors 14 may include sensors physically contained in or on the ESU 10, or also include sensors mounted elsewhere such as engine gauges that are in electronic communication with the ESU 10 or its associated ECS 20.

### Batteries and Other Energy Sources

The ESU 10 may be capable of charging, or supplementing the power provided from the batteries or other ESUs 10 including chemical and nonchemical batteries, such as but not limited to lithium batteries (including those with titanate, cobalt oxide, iron phosphate, iron disulfide, carbon monofluoride, manganese dioxide or oxide, nickel cobalt aluminum oxides, nickel manganese cobalt oxide, etc.), lead-acid batteries, alkaline or rechargeable alkaline batteries, nickel-cadmium batteries, nickel-zinc batteries, nickel-iron batteries, nickel-hydrogen batteries, nickel-metal-hydride batteries, zinc-carbon batteries, mercury cell batteries, silver oxide batteries, sodium-sulfur batteries, redox-flow batteries, supercapacitor batteries, and combinations or hybrids thereof.

### Power Input/Output Interface

The ESU 10 also includes or is associated with a power input/output interface 62 that can receive charge from a device (or a plurality of devices in some cases) such as the grid or from regenerative power sources in an electric vehicle (not shown), and can deliver charge to the device 16. The power input/output interface 62 may include one or more inverters, charge converters, or other circuits and devices to convert the current to the proper type (e.g., AC or DC) and voltage or amperage for either supplying power to, or receiving power from, the device to which it is connected. Bidirectional DC-DC converters may also be applied, as described in the case of electric vehicles in M. B. Camara et al., “Polynomial Control Method of DC/DC Converters for DC-Bus Voltage and Currents Management-Battery and Supercapacitors,” IEEE Transactions on Power Electronics, vol. 27, no. 3 (March 2012): 1455-67, DOI: 10.1109/TPEL.2011.2164581.

The power input/output interface 62 may be adapted to receive power from a wide range of power sources, such as via two-phase or three-phase power, DC power, etc., and may receive or provide power by wires or inductively or any other useful means. Converters, transformers, rectifiers, and the like may be employed as needed. The power received may be relatively steady from the grid or other sources at voltages such as 110V, 120V, 220V, 240V, etc., or may be from highly variable sources such as from solar or wind power where amperage or voltage may vary. DC sources may be, by way of example, from 1V to 1000V or higher, such as from 4V to 200V, 5V to 120V, 6V to 100V, 2V to 50V, 3V to 24V, or nominal voltages of about 4, 6, 12, 18, 24, 30, or 48 V. Similar ranges may apply to AC sources, but also including from 60V to 300V, from 90V to 250V, from 100V to 240 V, etc., operating at any useful frequency such as 50 Hz, 60 Hz, 100 Hz, etc.

Power received or delivered may be modulated, converted, smoothed, rectified, or transformed in any useful way to better meet the needs of the application and the requirements of the device and/or the ESU 10. The use of impedance matchers, for example, can help optimize the transfer of power from a photovoltaic array to a DC or AC source such as a powered device or the grid. For example, pulse-width modulation (PWM), sometimes called pulse-duration modulation (PDM), may be used to reduce the average power delivered by an electrical signal as it is effectively chopped into discrete parts. Likewise, maximum power point tracking (MPPT) may be employed to keep the load at the right level for the most efficient transfer of power.

The power input/out interface 62 may have a plurality of receptacles for receiving power and a plurality of outlets for providing power to one or more devices. Conventional AC outlets may include any known outlet such as those common in North America, various parts of Europe, China, Hong Kong, etc.

### ECS Components and Modules

### Processor

The processor 22 may include one or more microchips or other systems for executing electronic instructions and can provide instructions to regulate the charging and discharging hardware 56 and, when applicable, the configuration hardware 60 or other aspects of the ESU 10 and/or other aspects of the ECS 20 and its interactions with the device, the cloud, etc. In some cases a plurality of processors 22 may collaborate, including processors 22 installed with the ESU 10 and processors installed in a vehicle or other device.

### Memory

The memory 24 may include coding for operation of one or more of the ECS 20 modules and their interactions with each other or other components. It may also include information, such as databases pertaining to any aspect of the operation of the ECS 20. Additional databases 26 may be stored in a storage device, such as a hard disk drive, or may be available via the cloud. Such databases 26 can include a charging database that describes the charging and/or discharging characteristics of a plurality or all of the energy sources (the power packs and the batteries or other energy storage units), for guiding charging and discharging operations. Such data may also be included with energy-source-specific data provided by or accessed by the energy source modules 34.

The memory 24 may be in one or more locations or components, such as a memory chip, a hard drive, a cloud-based source or other computer readable medium, and may be in any useful form such as flash memory, EPROM, EEPROM, PROM, MROM, etc., or combinations thereof and in consolidated (centralized) or distributed forms. The memory 24 may in whole or in part be read-only memory (ROM) or random-access memory (RAM), including static RAM (SRAM), dynamic RAM (DRAM), synchronous dynamic RAM (SDRAM), and magneto-resistive RAM (MRAM), etc.

The ECS 20 may communicate with other entities via the cloud or other means, and such communication may involve information received from and/or provided to one or more databases 26 and a message center 62. The message center 62 can be used to provide alerts to an administrator responsible for the ESU 10 and/or the electric vehicle or other device. For example, an entity may own a fleet of electric vehicles using ESUs 10, and may wish to receive notifications regarding usage, performance, maintenance issues, and so forth. The message center 62 may also participate in authenticating the ESU 10 or verifying its authorization for use in the electric vehicle or other device via interaction with the security module 46.

### Energy Source Modules

The energy source modules 34 may include specific modules designed for the operation of a specific type of energy source such as supercapacitor module 34a, a lithium battery module 34b, a lead-acid battery module 34c, a hybrid module 34d, or other modules. Such modules may be associated with a database 26 of performance characteristics (e.g., charge and discharge curves, safety restrictions regarding overcharge, temperature, etc.) that may provide information for use by the safety module 48 and the charge/discharge module 36, which is used to optimize the way in which each unit within the power packs 12 or batteries or other ESUs 10 is used both in terms of charging and delivering charge. The charge/discharge module 36 seeks to provide useful work from as much of the charge as possible in the individual power packs 12 while ensuring that individual power packs 12 are fully charged but not damaged by overcharging. The charge/discharge module 36 can assist in directing the charging/discharging hardware 56, cooperating with the energy source modules 34. In one aspect, the ESU 10 thus may provide real-time charging and discharging of the plurality of power packs 12 while the electric vehicle is continuously accelerating and decelerating along a path.

### Charge/Discharge Module

The charge/discharge module 36 is used to optimize the way in which each unit within the power packs 12 or batteries or other ESUs 10 is used both in terms of charging and delivering charge. The charge/discharge module 36 seeks to provide useful work from as much of the charge as possible in the individual power packs 12 while ensuring during charging that individual power packs 12 are fully charged but not damaged by overcharging. The charge/discharge module 36 can assist in directing the charging/discharging hardware 56, cooperating with the energy source modules 34. In one aspect, the ESU 10 thus may provide real-time charging and discharging of the plurality of power packs 12 while the electric vehicle is continuously accelerating and decelerating along a path.

The charge/discharge module 36 may be configured to charge or discharge each of the plurality of power packs 12 up to a threshold limit. The charge/discharge module 36 may be communicatively coupled to the performance module 54, the energy source modules 34, and the identifier module 44, among others, and may communicate with the charging/discharging hardware 56 of the ESU 10. For example, in one aspect, the threshold limit may be more than 90 percent capacity of each of the plurality of power packs 12.

### Dynamic Module

The dynamic module 42 assists in coping with changes in operation including acceleration, deceleration, stops, changes in slopes (uphill or downhill), changes in traction or properties of the road or ground that affect traction and performance, etc., by optimizing the delivery of power or the charging that is taking place for individual power packs 12 or batteries or other ESUs 10. In addition to guiding the degree of power provided by or to individual power packs 12 based on current use of the device 16 and the individual state of the power packs 12, in some aspects the dynamic module 42 provides anticipatory management of the ESU 10 by proactively adjusting the charging or discharging states of the power packs 12 such that added power is available as the need arises or slightly in advance (depending on time constants for the ESU 10 and its components, anticipatory changes in status may only be needed for a few seconds (e.g., five seconds or less or two seconds or less) or perhaps only for 1 second or less such as for 0.5 seconds or less, but longer times of preparatory changes may be needed in other cases, such as from 3 seconds to 10 seconds, to ensure that adequate power is available when needed but that power is not wasted by changing the power delivery state prematurely. This anticipatory control can involve not only increasing the current or voltage being delivered, but also increasing the cooling provided by the cooling hardware of the charging and discharging hardware 56 in cooperation with safety module 48 and when suitable with the charge/discharge module 36.

The dynamic module 42 may be communicatively coupled to the charge/discharge module 36. The dynamic module 42 may be configured to determine the charging and discharging status of the plurality of power packs 12 and batteries or other ESUs 10 in real-time. For example, in one aspect, the dynamic module 42 may help govern bidirectional charge/discharge in real-time in which the electric charge may flow from the ESU 10 into the plurality of power packs 12 and/or batteries or other ESUs 10 or vice versa.

### Configuration Module

The ECS 20 may include a configuration module 40 configured to determine any change in configuration of charged power packs 12 from the charging module. For example, in one aspect, the configuration module 40 may be provided to change the configuration of the power packs 12, such as from series to parallel or vice versa. This may occur via communication with the charging/discharging hardware 56 of the ESU 10.

### Identifier Module

The identifier module 44, described in more detail hereafter, identifies the charging or discharging requirement for each power pack 12 to assist in best meeting the power supply needs of the device 16. This process may require access to database information about the individual power packs 12 from the energy source modules 34 (e.g., a supercapacitor module 34a) and information about the current state of the individual power packs 12 provided by the sensors 14 and charge and current detections circuits associated with the charging and discharging hardware 56, cooperating with the charge/discharge module 36 and, as needed, with the dynamic module 42 and the safety module 48.

### Safety Module

The sensors 14 may communicate with the safety module 48 to determine if the temperature of the power packs 12 and/or individual components therein show signs of excessive local or system temperature that might harm the components. In such cases, the safety module 48 interacts with the processor 22 and other features (e.g., data stored in the databases 26 of the cloud or in memory 24 pertaining to safe temperature characteristics for the ESU 10) to cause a change in operation such as decreasing the charging or discharging underway with the portions of the power packs 12 or other units facing excessive temperature. The safety module 48 may also regulate cooling systems that are part of the charging and discharging hardware 56 in order to proactively increase cooling of the power packs 12 or batteries or other ESUs 10, such that increasing the load on them does not lead to harmful temperature increase.

Thus, the safety module 48 may also interact with the dynamic module 42 in responding to forecasts of system demands in the near future for anticipatory control of the ESU 10 for optimized power delivery. In the interaction with the dynamic module 42, the safety module 48 may determine that an upcoming episode of high system demand from the device 16, such as imminent climbing of a hill, may impose excessive demands on a power pack already operating at elevated temperature, and thus make a proactive recommendation to increase cooling on the at-risk power packs 12. Other sensors 14, such as strain gauges, pressure gauges, chemical sensors, etc., may be provided to determine if any of the ESUs 10 in batteries or other ESUs 10 or the power packs 12 are facing pressure buildup from outgassing, decomposition, corrosion, electrical shorts, unwanted chemical reactions such as an incipient runaway reaction, or other system difficulties. In such cases, the safety module 48 may then initiate precautionary or emergency procedures such as a shut down, electrical isolation of the affected components, warnings to a system administrator via the communication module 38 to the message center 62, a request for maintenance to the maintenance module 50.

### Maintenance Module

The maintenance module 50 determines when the ESU 10 requires maintenance, either per a predetermined schedule or when needed due to apparent problems in performance, as may be flagged by the performance module 54, or in issues pertaining to safety as determined by the safety module 48 based on data from sensors 14 or the charging/discharging hardware 56, and in light of information from the energy sources modules 34. The maintenance module 50 may cooperate with the communication module 38 to provide relevant information to the display interface 64 and/or to the message center 62, where an administrator or owner may initiate maintenance action in response to the message provided. The maintenance module 50 may also initiate mitigating actions to be taken such as cooperating with the charge/discharge module 36 to decrease the demand on one or more of the power packs 12 in need of maintenance, and may also cooperate with the configuration module 40 to reconfigure the power packs 12 to reduce the demand in components that may be malfunctioning of near to malfunctioning to reduce harm and risk.

### Performance Module

The performance module 54 continually monitors the results obtained with individual power packs 12 and the batteries or other ESUs 10 and stores information as needed in memory 24 and/or in the databases 26 of the cloud or via messages to the message center 62. The monitoring is done through the use of the sensors 14 and the charging/discharging hardware 56, etc. The tracking of performance attributes of the individual energy sources can guide knowledge about the health of the system, the capabilities of the components, etc., which can guide decisions about charging and discharging in cooperation with the charge/discharge module 36. The performance module 54 compares actual performance, such as power density, charge density, time to charge, thermal behavior, etc., to specifications and can then cooperate with the maintenance module 50 to help determine if maintenance or replacement is needed and alert an administrator via the communication module 38 with a message to the message center 62 about apparent problems in product quality.

### Security Module

The security module 46 helps to reduce the risk of counterfeit products or of theft or misuse of legitimate products associated with the ESU 10, and thus can include one or more methods for authenticating the nature of the ESU 10 and/or authorization to use it with the device 16 in question. Methods of reducing the risk of theft of unauthorized use of an ESU 10 or its respective power packs 12 can include locks integrated with the casing of the ESU 10 that mechanically secure the ESU 10 in the electric vehicle or other device 16, wherein a key, a unique fob, a biometric signal such as a finger print or voice recognition system, or other security-related credentials may be required to enable removal of the ESU 10 or even operation thereof.

In another aspect, the ESU 10 includes a unique identifier (not shown) that can be tracked, allowing a security system to verify that a given ESU 10 is authorized for use with the device 16, such as an electric vehicle. For example, the casing of the ESU 10 or of one or more power packs 12 therein may have a unique identifier attached such as an RFID tag with a serial number (an active or passive tag), a holographic tag with unique characteristics equivalent to a serial number or password, nanoparticle markings that convey a unique signal, etc. One exemplary security tool that may be adapted for the security of the ESU 10 is a seemingly ordinary bar code or QR code with unique characteristics not visible to the human eye that cannot be readily copied, is the Unisecure™ technology offered by Systech (Princeton, N.J.), a subsidiary of Markem-Image, that essentially allows ordinary QR codes and barcodes to become unique, individual codes by analysis of tiny imperfections in the printing to uniquely and robustly identify every individual products, even if it seems that the same code is printed on each product. The technology is described in part in U.S. Pat. No. 10,380,601, “Method and system for determining whether a mark is genuine,” issued Aug. 13, 2019 to M. L. Soborski; U.S. Pat. No. 9,940,572, “Methods and a computing device for determining whether a mark is genuine,” issued Apr. 10, 2018 to M. L. Soborski; U.S. patent Ser. No. 10/235,597, “Methods and a computing device for determining whether a mark is genuine,” issued Mar. 19, 2019 to M. Voigt et al.; U.S. Pat. No. 9,519,942, “Methods and a computing device for determining whether a mark is genuine,” issued Dec. 13, 2016 to M. L. Soborski; and U.S. Pat. No. 8,950,662, “Unique identification information from marked features,” issued Feb. 10, 2015 to M. L. Soborski.

Yet another approach relies at least in part in the unique electronic signature of the ESU 10, and/or of one or more individual power packs 12 or of one or more supercapacitor units therein. The principle will be described relative to an individual power pack 12, but may be adapted to an individual supercapacitor or collectively to the ESU 10 as a whole. When a power pack 12 comprising supercapacitors is charged from a low voltage or relatively discharged state, the electronic response to a given applied voltage depends on many parameters, including microscopic details of the electrode structure such as porosity, pore size distribution, and distribution of coating materials, or details of electrolyte properties, supercapacitor geometry, etc., as well as macroscopic properties such as temperature. At a specified temperature or temperature range and under other suitable macroscopic conditions (e.g., low vibration, etc.), the characteristics of the power pack 12 may then be tested using any suitable tool capable of identifying a signature specific to the individual power pack. Such techniques may include impedance spectroscopy, cyclic voltammetry, etc., measured under conditions such as Cyclic Charge Discharge (CCD), galvanostatic charge/discharge, potentiostatic charge/discharge, and impedance measurements. etc. An electronic signature of time effects (characteristic changes in time of voltage or current, for example, is response to an applied load of some kind) may be explored for a specified scenario such as charging a 90% discharged power pack to a state of 50% charge or examining the response to difference applied voltages such as −3V to +4V. Voltammograms may be obtained showing, for example, the response of the power pack to different scan rates. See, for example, “Testing Super-Capacitors, Part 1: CV, EIS, and Leakage Current,” Apr. 16, 2015, https://www.gamry.com/assets/Uploads/Super-capacitors-part-1-rev-2.pdf, and “Testing Electrochemical Capacitors Part 2-Cyclic Charge Discharge and Stacks,” Nov. 14, 2011, https://www.gamry.com/assets/Application-Notes/Testing-Super-Capacitors-Pt2.pdf. Instrumentation for such testing may include a variety of electrical signal analysis tools, including, for example, the Gamry Instruments PWR800 system (Gamry Instruments Inc., Warminster, Pa.). Also see Erik Surewaard et al., “A Comparison of Different Methods for Battery and Supercapacitor Modeling,” SAE Transactions, Journal of Engines, vol. 112, Section 3 (2003): 1851-1859, https://www.jstor.org/stable/44741399. Also see Yuru Ge et al., “How to measure and report the capacity of electrochemical double layers, supercapacitors, and their electrode materials,” Journal of Solid State Electrochemistry, vol. 24 (2020): 3215-3230, https://link.springer.com/article/10.1007/s10008-020-04804-x.

Recognizing that the details of supercapacitor response to a certain load or charge/discharge process may vary gradually over time, especially if the supercapacitor has been exposed to excess voltage or other mechanical or electrical stress, the security module 46 can be adaptive and recognize and accept change within certain limits. Changes observed in the response characteristics can be used to update a security database or performance database for the ESU 10, so that future authentication operations will compare the measured behavior profile of the ESU's power pack in question with the updated profile for authentication purposes and for tracking of performance changes over time. Such information may also be shared with the maintenance module 50 (and may be stored in the database 26), which may trigger a request or requirement for service if there are indications of damage pointing to the need of repair or replacement. When a power pack 12 or supercapacitor therein is replaced due to damage, the response profile of the power pack 12 can then be updated in the security database. When such physical changes cause changes to the measured electronic characteristics that exceed a reasonable threshold, the authorization for use of that ESU 10 may be withdrawn pending further confirmation of authenticity or necessary maintenance.

In another aspect, each ESU 10 and optionally each power pack 12 of the ESU 10 may be associated with a unique identifier registered in a blockchain system, and each “transaction” of the ESU 10, such as each removal from a vehicle, maintenance operations, purchase or change in ownership, and installation into a vehicle or other device, can be recorded and tracked. A code, e.g., Radio Frequency Identification (RFID) signal, or other identifier may be read or scanned for each transaction, such that the blockchain record may then be updated. The blockchain record may include an information about the authorization state of the product, such as information on what vehicle or vehicles or products the ESU 10 is authorized for, or an identifier associated with the authorized user may be provided which can be verified or authenticated when the ESU 10 is installed in a new setting or when a transaction occurs. The authorization record may be updated at any time, including when a transaction occurs. Mechanisms may be provided by the vendor to resolve disputes regarding authorization status or other questions.

In some aspects, such as in military or government operation, the ESU 10 may include an internal “kill switch” or other inactivation device (not shown) that can be remotely activated by authorities in the event of a crime, unauthorized use, or violation of contract. Alternatively, or in addition, an electric vehicle or other device may be adapted to reject installation of an ESU 10 that is not authorized for use in the vehicle or device 16.

### Communication Module

The communication module 38 can govern communications between the ECS 20 and the outside world, including communications through the cloud, such as making queries and receiving data from various external databases or sending messages to a message center where they may be processed and archived by an administrator, a device owner, the device user, the ESU 10 owner, or automated systems. In some aspects, the communication module 38 may also oversee communication between modules or between the ESU 10 and the ECS 20, and/or work in cooperation with various modules to direct information to and from the display interface 64. Communications within a vehicle or between the ECS 20 or ESU 10 and the device may involve a DC bus 28 or other means such as separate wiring. Any suitable protocol may be used, including UART, LIN (or DC-LIN), CAN, SPI, I2C (including Intel's SMBus), and DMX (e.g., DMX512). In general, communications from the ECS 20 or ESU 10 with a device may be over a DC bus 28 or, if needed, over an AC/DC bus, or by separately wired pathways if desired, or may be wireless. Useful transceivers for communicating over DC lines include, for example, the SIG family and DCB family of transceivers from Yamar Electronics, LTD (Tel Aviv, Israel), and Yamar's DCAN500 device for CAN2.0 A/B protocol messages.

Communication to the cloud may occur via the communication module 38 and may involve a wired or a wireless connection. If wireless, various communication techniques may be employed such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques.

### Electrostatic Module

Assessment of charge in an ESU 10 can be conducted based on measurements made with the charging/discharging hardware 56, in communication with certain modules of the ECS 20. In general, the measurement of charge and processing of the data can be said to be managed by an electrostatic module.

The electrostatic module 52 may be configured to identify the power pack type and the capacity of each power pack connected to the modular multi-type power pack ESU 10. Further, the electrostatic module may be configured to retrieve information related to the type of power packs 12 from the charging database 26. The electrostatic module 52 may determine the capacity of each power pack to be charged and may be configured to determine the capacity of each power pack when connected to the modular multi-type power pack ESU 10.

The electrostatic module may be configured to determine if each power pack charged below the threshold limit. For example, in one aspect, the electrostatic module 52 may check whether each of the plurality of power packs 12 may have capacity below the threshold limit. The electrostatic module 52 may also be configured to send data related to power packs 12 to the ECS 20.

### Various Databases

The ECS 20 may access various databases 26 locally or via an interface to the cloud and store retrieved information in the memory 24 for use to guide the various modules.

Further, the memory 24 may include a charging database 26 or information from such a database obtained from the databases 26 located in the cloud or otherwise. In one aspect, the charging database 26 may be configured to store information related to various power packs 12 used while charging and discharging from the ESU 10. In one aspect, the charging database 26 may be configured to store information related to the power cycle of each of the plurality of power packs 12, the maximum and minimum charge for different types of power packs 12, and the state of charge (SoC) profile of each of the plurality of power packs 12.

The charging database 26 may be configured to store information related to the management of the plurality of power packs 12, such as the type of power pack to be charged, safety specifications, recent performance data, bidirectional charging requirements or history of each of the plurality of power packs 12, etc. In another aspect, the stored information may also include, but is not limited to, the capacity of each of the plurality of power packs 12, amount of charge required for one trip of the device 16 along the path, such as golf course, etc., charging required for a supercapacitor unit, etc. In another aspect, the charging database 26 may provide a detailed research report for the device's average electric charge consumption over a path. In one aspect, the charging database 26 may be configured to store information of the consumption of the electric charge per unit per kilometer drive of the device 16 from the plurality of power packs 12. For example, such information may indicate that a golf cart is equipped with five supercapacitor-driven power packs 12 each at 90% charge, with each power pack able to supply a specified amount of ampere hours (Ah) of electric charge resulting in an ability to drive under normal conditions at top speed for, e.g., 80 kilometers. The information may also indicate that a solar cell installed on the roof of the golf cart would, under current partly clouded conditions, still provide enough additional charge over the planned period of use to extend the capacity of the ESU 10 by another 40 kilometers for 1 passenger.

The charging database 26 may be used by the performance module 54 for both reading data and storing new data on the individual energy storage units 10, such as the power packs 12.

### Power Pack

The power pack 12 is a unit that can store and deliver charge within an ESU 10 and includes one or more supercapacitors such as supercapacitors in series and/or parallel. It may further include or cooperate with sensors 14, e.g., temperature sensors, charge and current sensors (circuits or other devices), connectors, switches such as crosspoint switches 32, safety devices, and control systems, such as charge and discharge control systems. In various aspects described herein, the power pack 12 may include a plurality of supercapacitors and have an energy density greater than 200 kWhr/kg, 230 kWhr/kg, 260 kWhr/kg, or 300 kWhr/kg, such as from 200 to 500 kWhr/kg, or from 250 to 500 kWhr/kg. The power pack 12 may have a functional temperature range from −70° C. to 150° C., such as from −50° C. to 100° C. or from −40° C. to 80° C. The voltage provided by the power pack may be any practical value such as 3V or greater, such as from 3V to 240 V, 4V to 120 V, etc.

By way of example, a power pack 12 may include one or more units each comprising at least one supercapacitor having a nominal voltage from 2 to 12 V such as from 3 to 6 V, including supercapacitors rated at about 3, 3.5, 4, 4.2, 4.5, and 5 V. For example, a power pack 12 may be provided with 14 capacitors in series and five series in parallel and charged with 21,000 F at 4.2 V to provide 68-75 Wh. Power packs 12 may be packaged in protective casings that allow them to be easily removed from an ESU 10 and replaced. They may also include connectors for charging and discharging. Power packs 12 may be provided with generally rectilinear casings or they may have cylindrical or other useful shapes.

### Supercapacitors

Principles for the design, manufacture, and operation of supercapacitors included in one or more power packs 12 are described, by way of example, in U.S. Pub. No. 2019/0180949, “Supercapacitor,” published Aug. 29, 2017 by Liu Sizhi et al. and PCT Pub. No. WO2018041095, “Supercapacitor,” published Mar. 8, 2018 by Liu Sizhi et al.; U.S. Pat. No. 9,318,271, “High temperature supercapacitor,” issued Apr. 19, 2016 to S. Fletcher et al.; US20150047844, “Downhole supercapacitor device”; U.S. Pub. No. 2020/0365336, “Energy storage device Supercapacitor and method for making the same”; U.S. Pat. No. 9,233,860, “Supercapacitor and method for making the same”; and U.S. Pat. No. 9,053,870, “Supercapacitor with a meso-porous nano graphene electrode.” Also see Chinese Pat. No. CN 106252099B, “Supercapacitor” by Liu Sizhi et al., published Apr. 10, 2018; Chinese Pat. No. CN 106252096B, “Supercapacitor” by Liu Sizhi et al., published Jan. 23, 2018; and Chinese Pat. No. CN 104057901B, “Automobile Power-supply Management System with Supercapacitor” by Yang Weiming et al., published Apr. 27, 2016.

A supercapacitor may have two electrode layers separated by an electrode separator wherein each electrode layer is electrically connected to a current collector supported upon an inert substrate layer, an electrolyte-impervious layer disposed between each electrode layer and each conducting layer to protect the conducting layer, and a liquid electrolyte disposed within the area occupied by the working electrode layers and the electrode separator. The liquid electrolyte may be an ionic liquid electrolyte gelled by a silica gellant or other gellant to inhibit electrolyte flow.

The supercapacitor may include an electrode plate, an isolation film, a pole, and a shell, wherein the electrode plate includes a current collector and a coating is disposed on the current collector. The coating may include an active material that may include carbon nanomaterial, such as graphene or carbon nanotubes, including nitrogen-doped graphene, a carbon nitride, carbon materials doped with a sulfur compound, such as thiophene or poly 3-hexylthiophene etc., or graphene on which is deposited nanoparticles of metal oxide such as manganese dioxide. The coating may further include a conductive polymer, such as one or more of polyaniline, polythiophene and polypyrrole. Such polymers may be doped with a variety of substances including boron (especially in the case of polyaniline). Nitrogen doping, for example, is described more fully by Tianquan Lin et al, “Nitrogen-doped mesoporous carbon of extraordinary capacitance for electrochemicalenergy storage,” Science (new series), vol. 350, no. 6267 (18 Dec. 2015): 1508-1513, https://www.jstor.org/stable/24741499.

Electrodes in supercapacitors may have thin coatings in electrical communication with a current collector. To provide high electrode surface area for high performance, electrodes may include porous material with high specific surface area such as graphene, graphene oxide, or various derivatives of graphene, carbon nanotubes or other carbon nanomaterials including activated carbon, nitrogen doped graphene or other doped graphene, graphite, carbon fiber-cloth, carbide-derived carbon, carbon aerogel, and/or may include various metal oxides such as oxides of manganese, etc., and all such materials may be provided in multiple layers and generally planar, cylindrical, or other geometries. Electrolytes in the supercapacitor may include semi-solid or gel electrolytes, conductive polymers or gels thereof, ionic liquids, aqueous electrolytes, and the like. Solid-state supercapacitors may be used.

Supercapacitors may be provided with various indicators and sensors 14 pertaining to charge state, temperature, and other aspects of performance and safety. An actuation mechanism may be integrated to prevent undesired discharge.

The voltage of an individual supercapacitor may be greater than 2 V such as from 2.5 V to 5 V, 2.7 V to 8 V, 2.5 V to 4.5 V, etc.

### Powered Devices

Powered devices 16 that may be powered by the ESU 10 can include electric vehicles and other transportation devices of all kinds, such as those for land, water, or air, whether adapted to operate without passengers or with one or more passengers. Electric vehicles may include, without limitation, automobiles, trucks, vans, fork lifts, carts, such as golf carts or baby carts, motorcycles, electric bikes scooters, autonomous vehicles, mobile robotic devices, hoverboards, monowheels, Segways® and other personal transportation devices, wheelchairs, drones, personal aircraft for one or more passengers and other aeronautical devices, robotic devices, aquatic devices such as boats or personal watercraft such as boats, Jet Skis®, diver propulsion vehicles or underwater scooters, and the like. The electric vehicle generally includes one or more motors connected to the ESU 10 and ECS 20 that controls the power delivered from the ESU 10, and may include a user interface that provides information and/or control regarding the delivery of power from the ESU 10 as well as information regarding performance, remaining charge, safety, maintenance, security, etc. Not all transportation devices require non-stationary motors. An elevator, for example, may have a substantially stationary motor while the cabin moves between level of a structure. Other transport systems with mobile cabins, seats, or walkways may be driven by stationary motors driving cables, chains, gears, bands, etc.

Principles for the manufacture and design of electric vehicles and aspects of their charging are provided in U.S. Pub. No. 2019/0061541, “Electric vehicle batteries and stations for charging batteries”; European Pat. No. EP2278677B, “Safety Switch for Secondary Battery for Electric Vehicle and Charging/Discharging System for Secondary Battery for Electric Vehicle Using the Same”; U.S. Pub. No. 2019/0061541, “Electric vehicle batteries and stations for charging batteries,” etc. The relationship between the ESU 10 and the drive train, especially when individual control of wheel speed is provided, can be optimized with neural network systems for traction control and efficiency. See Abdelhakim Haddoun, “Modeling, Analysis, and Neural Network Control of an EV Electrical Differential,” IEEE TRANSACTIONS ON INDUSTRIAL ELECTRONICS, vol. 55, no. 6 (June 2008): 2286-94, https://www.researchgate.net/publication/3219993.

Apart from electric vehicles, there are many other devices 16 that may be powered by the ESU 10 in cooperation with the ECS 20. Such other devices can include generators, which in turn can power an endless list of electric devices in households and industry. ESUs 10 of various size and shape can also be integrated with a variety of motors, portable devices, wearable or implantable sensors, medical devices, acoustic devices such as speakers or noise cancellation devices, satellites, robotics, heating and cooling devices, lighting systems, rechargeable food processing tools and systems of all kinds, personal protection tools such as tasers, lighting and heating systems, power tools, computers, phones, tablets, electric games, etc. In some versions, the device being powered is the grid, and in such versions, the ESU 10 may include an inverter to turn DC current into AC current suitable for the grid.

In some aspects, a plurality of devices 16, such as electric vehicles, may be networked together via a cloud-based network, wherein the devices 16 share information among themselves and/or with a central message center 62 such that an administrator can assist in managing the allocation of resources, oversee maintenance, evaluate performance of vehicles and ESUs 10, upgrade software or firmware associated with the ECS 20 to enhance performance for the particular needs of individual users or a collective group, adjust operational settings to better cope with anticipated changes in weather, traffic conditions, etc., or otherwise optimize performance.

### Implementation in Hybrid Vehicles

When installed in electric vehicles, the ESU 10 may include both power packs 12, as well as one or more lead-acid batteries or other batteries. The ESU 10 may power both the motor as well as the on-board power supply system.

### Motors

Any kind of electric motor may be powered by the ESU 10. The major classes of electric motors are: 1) DC motors, such as series, shunt, compound wound, separately excited (wherein the connection of stator and rotor is done using a different power supply for each), brushless, and PMDC (permanent magnet DC) motors, 2) AC motors, such as synchronous, asynchronous, and induction motors (sometimes also called asynchronous motors), and 3) special purpose motors, such as servo, stepper, linear induction, hysteresis, universal (a series-wound electric motor that can operate on AC and DC power), and reluctance motors.

### Display Interface

The display interface 64 of the ECS 20 may be displayed on or in the device 16, such as on a touch screen or other display in a vehicle or on the device 16, or it may be displayed by a separate device, such as the user's phone. The display interface 64 may include or be part of a graphic user interface such the control panel (e.g., a touch panel) of the device 16. The display interface may also include audio information and verbal input from a user. It may also be displayed on the ESU 10 itself or on a surface connected to or in communication with the ESU 10. In one version, the display interface 64 may include, but is not limited to, a video monitoring display, a smartphone, a tablet, and the like, each capable of displaying a variety of parameters and interactive controls, but the display interface 64 could also be as simple as one or more lights indicating charging or discharging status and optionally one or more digital or analog indicators showing remaining useful lifetime, % power remaining, voltage, etc. Further, the display interface 64 may be any state-of-the-art display means without departing from the scope of the disclosure. In some aspects, the display interface 64 provides graphical information on charge status, including one or more of fraction of charge remaining or consumed, remaining useful life of the ESU 10 or its components (e.g., how many miles of driving or hours of use are possible based on current or projected conditions or based on an estimate of the average conditions for the current trip or period of use), and may also provide one or more user controls to allow selection of settings. Such settings may include low, medium, or high values for efficiency, power, etc.; adjustment of operating voltage when feasible; safety settings (e.g., prepare the ESU 10 for shipping, discharge the ESU 10, increase active cooling, only apply low power, etc.); planned conditions for use (e.g., outdoors, high-humidity, in rain, underwater, indoors, etc.). Selections may be made through menus and/or buttons on a visual display, through audio presentation of information responsive to verbal commands, or through text commands or displays transmitted to a phone or computer, including text messages or visual display via an app or web page.

Thus, the ESU 10 may include a display interface 64 coupled to the processor 22 to continuously display the status of charging and discharging the plurality of power packs 12.

### Solar Power and Alternative Energy Systems

The ESU 10 may receive energy from solar panels coupled through one or more solar regulators and/or inverters. Solar panels produce electrical power through the photovoltaic effect, converting sunlight into DC electricity. This DC electricity may be fed to a battery via a solar regulator to ensure proper charging and prevent damage to the power pack 12. While DC devices can be powered directly from the battery or the regulator, AC devices require an inverter to convert the DC electricity to suitable AC current at, for example, 110V, 120V, 220V, 240V, etc.

Solar panels may be wired in series or in parallel to increase voltage or current, respectively. The rated terminal voltage of, e.g., a 12 Volt solar panel may actually be around 17 Volts, but the regulator may reduce the voltage to a lower level required for battery charging.

### Solar Regulators

Solar regulators (also called charge controllers) regulate current from the solar panels to prevent battery overcharging, reducing, or stopping current as needed. They may also include a Low Voltage Disconnect feature to switch off the supply to the load when battery voltage falls below the cut-off voltage and may also prevent the battery sending charge back to the solar panel in the dark.

Regulators may operate with a pulse width modulation (PWM) controller, in which the current is drawn out of the panel at just above the battery voltage, or with a maximum power point tracking (MPPT) controller, in which the current is drawn out of the panel at the panel “maximum power voltage,” dropping the current voltage like a conventional step-down DC-DC converter, but adding the “smart” aspect of monitoring of the variable maximum power point of the panel to adjust the input voltage of the DC-DC converter to deliver optimum power.

### Inverters

Inverters are devices that convert the DC power to AC electricity. They come in several forms, including on-grid solar inverters that convert the DC power from solar panels into AC power which can be used directly by appliances or be fed into the grid. Off-grid systems and hybrid systems can also provide power to batteries for energy storage but are more complex and costly that on-grid systems, requiring additional equipment. An inverter/charger that manages both grid connection and the charging or discharging of batteries may be called interactive or multi-mode inverters. A variation of such inverters is known as the all-in-one hybrid inverter.

Output from inverters may be in the form of a pure sine wave or a modified sine wave or square wave. Some electronic equipment may be damaged by the less expensive modified sine wave output. In many conventional systems, multiple solar panels are connected to a single inverter in a “string inverter” setup. This can limit system efficiency because, when one solar panel is shaded and has reduced power, the overall current provided to the inverter is likewise reduced. String solar inverters are provided in single-phase and three-phase versions.

Microinverters are miniature forms of inverters that can be installed on the back of individual solar panels, providing the option for AC power to be created directly by the panel. For example, LG (Seoul, Korea) produces solar panels with integrated microinverters. Unfortunately, microinverters limit the efficiency of battery charging because the AC power from the panels must be converted back to DC power for battery charging. They also add significant cost to the panels. The additional equipment on the panel may also increase maintenance problems and possibly the risk of lightning strikes. Microinverters generally use maximum power point tracking (MPPT) to optimize power harvesting from the panel or module it is connected to. An example of a microinverter is the Enphase M215 of Enphase Energy (Fremont, Calif.).

The on-grid string solar inverters and microinverters, collectively often simply called solar inverters, provide AC power that can be fed to the grid or directly to a home or office. Alternatively, off-grid inverters (or “battery inverters”) or hybrid inverters can charge batteries. Hybrid inverters can be used to charge batteries with DC current and to provide AC current for the grid or local devices, combining a solar inverter and battery inverter/charger into a single unit. An example of a hybrid inverter is the Conext SW 120/240 VAC hybrid inverter charger 48 VDC (865-4048) by Schneider Electric (Rueil-Malmaison, France) is a 4 kW (4000 watt) pure sine wave inverter or the 2.3 kW Outback Power Hybrid On/Off-grid Solar Inverter Charger 1-Ph 48 VDC by Outback Power (Phoenix, Ariz.).

### Machine Learning and AI

The ECS 20 or central systems in communication with the ECS 20 may employ machine learning, including neural networks and other AI systems, to learn performance profiles for individual power packs 12, including supercapacitors, or entire ESUs 10, or those of a managed fleet of vehicles of collection of devices 16, in order to better estimate and optimize performance including such factors as remaining charge, remaining useful life, times for maintenance, methods for charge control to reduce overheating or to prevent other excursions or safety issues, and strategies to optimize lifetime or power delivery with a given ECS 20. Methods for adaptive learning, neural network analysis, or AI development that can be used with supercapacitor systems or the ESUs 10 described herein include Jean-Noel Marie-Frangoise et al., “Supercapacitor modeling with Artificial Neural Network (ANN),” https://www.osti.gov/etdeweb/servlets/purl/20823689, accessed Nov. 1, 2021, which describes an Artificial Neural Network (ANN) using a black box nonlinear multiple inputs single output (MISO) model in which the system inputs are temperature and current, the output is the supercapacitor voltage. See also Elena Danila et al., “Dynamic Modelling of Supercapacitor Using Artificial Neural Network Technique,” International Conference and Exposition on Electrical and Power Engineering, October 2014, DOI: 10.1109/ICEPE.2014.6969988 and https://www.researchgate.net/publication/270888480_Dynamic_Modelling_of Supercapacitor_Using_Artificial_Neural_Network_Techni que, which describes a feed forward artificial neural network structure with two hidden layers and with backpropagation training. Similar systems may be adapted for anticipatory power control as described herein. Also see Akram Eddahech, “Modeling and adaptive control for supercapacitor in automotive applications based on artificial neural networks,” Electric Power Systems Research, vol. 106 (January 2014): 134-141, https://www.sciencedirect.com/science/article/abs/pii/S0378779613002265, which seeks to predict power cycle behavior for supercapacitors using a one-layer feed-forward artificial neural network (ANN). Related publications include U.S. Pub. No. 20190097362, “Configurable Smart Object System with Standard Connectors for Adding Artificial Intelligence to Appliances, Vehicles, and Devices,” published Mar. 28, 2019 by B. Haba et al.; U.S. Pat. No. 9,379,546, “Vector control of grid-connected power electronic converter using artificial neural networks,” issued Jun. 28, 2016 to S. Li et al.; U.S. Pat. No. 7,548,894, “Artificial neural network,” issued Jun. 16, 2009 to Y. Fuji; and U.S. Pub. No. 20160283842, “Neural Network and Method of Neural Network Training United,” issued Sep. 29, 2016 to D. Pescianschi.

All patents and applications cited are to be understood as being incorporated by reference to the degree they are compatible.

For all ranges given herein, it should be understood that any lower limit may be combined with any upper limit when feasible. Thus, for example, citing a temperature range of from 5° C. to ° C. and from 20° C. to 200° C. would also inherently include a range of from 5° C. to 200° C. and a range of 20° C. to ° C.

When listing various aspects of the products, methods, or system described herein, it should be understood that any feature, element, or limitation of one aspect, example, or claim may be combined with any other feature, element, or limitation of any other aspect when feasible (i.e., not contradictory). Thus, disclosing an example of a power pack comprising a temperature sensor and then a different example of a power pack associated with an accelerometer would inherently disclose a power pack comprising or associated with an accelerometer and a temperature sensor.

Unless otherwise indicated, components such as software modules or other modules may be combined into a single module or component or divided. The function involves the cooperation of two or more components or modules. Identifying an operation or feature as a single discrete entity should be understood to include division or combination such that the effect of the identified component is still achieved.

Some embodiments of this disclosure, illustrating all its features, will now be discussed in detail. It can be understood that the embodiments are intended to be open-ended in that an item or items used in the embodiments is not meant to be an exhaustive listing of such items or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used to practice or test embodiments, only some exemplary systems and methods are now described.

FIG. 1B is a block diagram a modular power pack system 100 for an electric vehicle (EV). The modular power pack system 100 may include the electric vehicle 102 in some embodiments. The electric vehicle 102 may be, without limitation, a golf cart, an electric car, and an electric bike. In one embodiment, the modular power pack system 100 may be referred to as a system for enhancing the capability of the electric vehicle 102 using ultra-capacitors or supercapacitors in series or parallel. Further, the modular power pack system 100 may provide a smart energy management system to supply electric charge to the vehicle motor of the electric vehicle 102 from supercapacitors in a controlled manner to maximize charge efficiency. The modular power pack system 100 may provide ultra-capacitors with real-time charging and discharging while the electric vehicle 102 is continuously accelerating and decelerating along a predefined path. In one embodiment, the modular power pack system 100 may be referred to as a modular graphene supercapacitor power pack for powering the electric vehicle 102.

The modular power pack system 100 may include an energy management database 104 communicatively coupled to the electric vehicle 102 via a cloud 106 or directly to a processor 116. The energy management database 104 may be accessible via an energy management network provided by the cloud 106 or another network.

In one embodiment, the energy management database 104 may be configured to provide historical data related to the electric vehicle 102. In another embodiment, the energy management database 104 may provide a report for an average charge consumption of the electric vehicle 102 over one or more predefined paths. In one embodiment, the energy management database 104 may store information related to supercapacitor units, electric charge percentage, acceleration of an electric motor, and electric charge in the supercapacitor units, as well as data for individual drivers, driving conditions (e.g., temperature, weather, time of year or day), power pack identity or characteristics, the mass of the vehicle and passengers and cargo (which may require load cells installed in the vehicle or an external device for weighing the vehicle), etc.

The cloud 106 may provide a communication link among the components of the modular power pack system 100. The cloud 106 may be a wired and a wireless network. The cloud 106, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), radio waves, and other communication techniques known in the art. In some embodiments, the cloud connection could be replaced by a “bus” to connect the processor to any other controller or memory 118.

Further, the modular power pack system 100 may include a plurality of supercapacitor units 108 disposed within the electric vehicle 102. An individual superconductor unit 108 could be, for example, a 21,000 F 4.2V nano-pouch graphene energy module with a final 48V 100AH Graphene Power Pack. An individual superconductor unit 108 may contain many layers of a graphene lattice matrix structure deposited using a method of electropolymerization that provides a highly dense energy storage module design with high-current energy transfer. Due to the tightly coupled nanotechnology design and manufacturing methods, energy storage and delivery can be cycled thousands of times without matrix degradation. This power pack is graphene-based and contains no lithium or other chemical conversion components. In one embodiment, the plurality of supercapacitor units 108 may be continuously charged in real-time, depending upon the usage of the electric vehicle 102, such as through the use of solar panels, inductive charging, etc., and optionally by redistributing charge among individual supercapacitors or supercapacitor units (a single supercapacitor unit 108 may include multiple supercapacitors internally). Alternatively or in addition, supercapacitor units 108 may be charged while connected to a suitable charging source such as an AC power line (not shown) or DC power (not shown) or using an alternative energy source, such as solar power, wind power, etc., where a trickle charging system may be applied.

The plurality of supercapacitor units 108 may include an input port 110 and an output port 112. The input port 110 may be provided to charge the plurality of supercapacitor units 108. The output port 112 may be provided to connect the plurality of supercapacitor units 108 to the electric vehicle 102 or any other device. Input port 110 and output port 112 may be used for testing the supercapacitor unit 108. In one embodiment, the output port 112 may be provided with a connector to connect the plurality of supercapacitor units 108 to the electric vehicle 102. Each of the plurality of supercapacitor units 108 may include a plurality of power pack units coupled to each other in series or parallel. In one embodiment, the plurality of supercapacitor units 108 may enhance the performance of the electric vehicle 102 by supplying the electric charge according to the desired need of the electric vehicle 102.

The charging and discharging of each of the plurality of supercapacitor units 108 may be displayed over a display interface 114. In one embodiment, the display interface 114 may be integrated within the electric vehicle 102. The display interface 114 may include, but is not limited to, a video monitoring display, a smartphone, and a tablet, each capable of displaying a variety of parameters and interactive controls, but could also be as simple as one or more lights indicating charging or discharging status and optionally one or more digital or analog indicators showing remaining useful lifetime, % power remaining, voltage, vehicle range, etc.

Instructions related to managing the plurality of supercapacitor units 108 may be stored in the energy management database 104. Further, a user may retrieve the store instructions from the energy management database 104 before driving the electric vehicle 102. In one embodiment, the stored instructions may include, but are not limited to, the capacity of each of the plurality of supercapacitor units 108, amount of charge required for one trip of electric vehicle 102 along the path, charging required for a supercapacitor unit 108, and acceleration and deceleration data related to the path of the electric vehicle 102. The energy management database 104 need not include details about the route and its characteristics. Nevertheless, it may interact with a GPS, terrain database, or other sources of information to enable any needed computations.

The modular power pack system 100 may be operatively associated with a processor 116, a memory 118, and a design database 120. In one embodiment, the processor 116 may be included within the electric vehicle 102 or integrated within the casing or other components of the modular power pack system 100 or may have components distributed in two or more locations. Further, the processor 116 may be configured to retrieve information about the electric vehicle 102 and the plurality of supercapacitor units 108 from the energy management database 104, as well as the terrain or route, and other parameters via the cloud 106 and other remote sources. In one embodiment, the retrieved information related to the electric vehicle 102 may be stored in real-time into the memory 118.

The memory 118 may be configured to retrieve information related to the performance of the electric vehicle 102 from the design database 120. In one embodiment, the design database 120 may be configured to store the consumption of electric charge per unit per kilometer drive of the electric vehicle 102. For example, an electric vehicle 102 with ten supercapacitor units installed consumes 5 kW/h of electric charge for one hour to drive the electric vehicle 102 for a distance of one kilometer at a characteristic speed of 7 m/s (about 16 mph) with an initial acceleration of, e.g., 23 m/s². Further, an electric vehicle 102 with fifteen supercapacitor units 108 installed may consumes 8 kW/h of electric charge for one hour to drive the electric vehicle 102 for a distance of one kilometer with an acceleration of 42 m/s². Further, an electric vehicle 102 with thirteen supercapacitor units installed may consume 4 kW/h of electric charge for one hour to drive the electric vehicle 102 for a distance of one kilometer with an acceleration of 26 m/s². Further, an electric vehicle 102 with twelve supercapacitor units installed may consume 3 kW/h of electric charge for one hour to drive the electric vehicle 102 for a distance of one kilometer with an acceleration of 24 m/s². Further, an electric vehicle 102 with twenty supercapacitor units installed may consume 10 kW/h of electric charge for one hour to drive the electric vehicle 102 for a distance of one kilometer with an acceleration of 46 m/s².

The modular power pack system 100 may include a plurality of modules to evaluate and enhance the performance of the electric vehicle 102. In one embodiment, the modular power pack system 100 may include or be operatively associated with a base module 122 communicatively coupled to the processor 116. In another embodiment, base module 122 may reside in whole or in part in memory 118. In one embodiment, the base module 122 may act as a central module to receive and send instructions to/from each of the plurality of modules. In one embodiment, the base module 122 may be configured to manage at least two parameters related to the electric vehicle 102, such as, without limitation, electric charge of the plurality of supercapacitor units 108 and the performance of the electric vehicle 102 when the electric vehicle 102 receives a predefined amount of electric charge from the plurality of supercapacitor units 108.

In one embodiment, the base module 122 may include an energy optimization module 124 to optimize the electric charge of the plurality of supercapacitor units 108. The energy optimization module 124 may be configured to determine the percentage of electric charge available in each of the plurality of supercapacitor units 108. In another embodiment, the energy optimization module 124 may be configured to collect data related to each of the plurality of supercapacitor units 108 required for one run time of the electric vehicle 102 along the predefined path. The energy optimization module 124 is designed to rely on supercapacitors' premeasure performance, such as the charge curve over time and the discharge curve overtime at various loads. Once this premeasured performance is defined, it is stored in a database. The energy optimization module 124 may also rely on other curves, such as voltage vs. current charge and discharge curves, temperature as a discharge function under various loads, humidity versus storage time as a particular voltage, etc. The energy optimization module 124 may evaluate the future load prediction due to a user-defined map, where the energy optimization module 124 may determine that five out of ten batteries would be sufficient for the prediction, so the energy optimization module 124 may inform the base module 122 which batteries may be used for the predicted trip. The energy optimization module 124, using capacitor premeasurements, may determine that, even though five out of ten batteries would be sufficient for the preplanned trip, seven of the ten supercapacitor batteries are used, leaving seven of ten batteries with usable future charge and three of the ten batteries left fully charges in case there is a deviation from the planned trip. The energy optimization module 124 may be used in preplanned route optimization or route optimization in many ways, including, but not limited to, Artificial Intelligence analysis of historical data, historical data on actual use of a common route, etc. Since graphene-based supercapacitors have unique “signatures of performance” based upon pre measurements above that are different than, for example, lead-acid batteries or lithium-ion batteries, the unique “signatures of performance” using the energy optimization module 124 will make the driving experience of the EV using the graphene-based supercapacitors to be a least the same if not better experience than if the EV used lead-acid batteries or lithium-ion batteries, that is, less likely to have battery failures, batteries losing power uphill, batteries running out when traveling, etc.

The base module 122 may include a charging module 126 configured to evaluate the charging requirement of each of the plurality of supercapacitor units 108. In one embodiment, the charging module 126 may be activated and deactivated automatically by the base module 122 upon receiving a request from the energy optimization module 124 related to the requirement of the electric charge to drive the electric vehicle 102. For example, if there are enough battery units with sufficient charge for running the EV at certain speeds for a certain amount of time (average power consumption), the charging module 126 is deactivated. If there are not enough battery units with sufficient charge for running the EV at certain speeds for a certain time (average power consumption), the charging module 126 is activated.

In one embodiment, the charging module 126 may be configured to retrieve data related to each of the plurality of supercapacitor units 108 from the energy management database 104. In one embodiment, the data related to each of the plurality of the supercapacitor units 108 may correspond to an amount of electric charge stored in each of the plurality of supercapacitor units 108. In another embodiment, the charging module 126 may be configured to analyze and compare the data retrieved from the energy management database 104 concerning the data related to each of the plurality of supercapacitor units 108. Further, the charging module 126 may determine whether charging is needed.

The base module 122 may also include a maintenance module 128 to maintain the electric vehicle 102. In one embodiment, the maintenance module 128 may be configured to run internal maintenance of the electric vehicle 102 and the plurality of supercapacitor units 108 after the base module 122 receives a notification from the charging module 126. Further, the maintenance module 128 may determine whether the electric vehicle 102 is consuming the electric charge more than the desired charge for a particular run time, where a maintenance check may be needed. In one embodiment, the maintenance module 128 may initiate a maintenance request to the base module 122, indicating that the plurality of supercapacitor units 108 is not coupled correctly or the electric vehicle 102 is experiencing more load while driving over the predefined path. The maintenance module 128 may determine the performance of the electric vehicle 102 for retrieved performance from the design database 120 and the energy management database 104. In one embodiment, the maintenance module 128 may perform an internal maintenance check-up to determine whether each component of the electric vehicle 102 is functioning up to its desired requirement.

The base module 122 may further include a speed optimization module 130 configured to provide the predefined path of the electric vehicle 102. The speed optimization module 130 may also be referred to as a range optimization module in one embodiment. The speed optimization module 130 may enhance the performance of the electric vehicle 102 by minimizing the consumption of electric charge. In one embodiment, the speed optimization module 130 may be configured to provide a road map for the electric vehicle 102. The road map may be a graph or a curve with anticipated acceleration and deceleration points along the predefined path with areas where the drain is used and where it is not (hills drain batteries significantly, while valleys drain the battery far less). Therefore, the electric vehicle 102 may consume electric charge only when accelerating over a steep curve and may stop the flow of the electric charge while moving downwards on a steep curve. The speed optimization module 130 may retrieve information related to maintenance of the electric vehicle 102 from the design database 120 to measure the amount of electric charge consumed by the electric vehicle 102 before maintenance.

The base module 122 may also include a control module 132 configured to determine the best use of the electric charge from the plurality of supercapacitor units 108. In one embodiment, the control module 132 may be configured to retrieve information related to the ideal consumption of the electric charge of the electric vehicle 102 from the energy management database 104. Further, the control module 132 may use information from the energy optimization module 124, the charging module 126, the maintenance module 128, and the speed optimization module 130 to determine the best use of the electric charge. For example, the control module 132 retrieves from the energy management database 104 an indication that the electric vehicle 102 should consume 3 kWh per kilometer of electric charge. However, the maintenance module 128 and the speed optimization module 130 provide information that the electric vehicle 102 is consuming 4 kWh per kilometer of electric charge. Therefore, the control module 132, using the anticipated acceleration and deceleration map, can determine the optimal use of the electric charge to manage overall Watt-hour consumption over time. The control module 132 may be configured to effectively manage the plurality of supercapacitor units 108 in series or parallel.

In one embodiment, the base module 122 may include a communication module 134 configured to facilitate communication between the base module 122 and the plurality of supercapacitor units 108. Communications module 134 covers internal messaging and control data internally to the system 100 and messaging to the user using the display interface 114. The base module 122 may determine the number of supercapacitor units being used in the electric vehicle 102 in real-time. In one embodiment, the communication module 134 may be configured to provide an exact figure for connections of the supercapacitor units 108 for the plurality of supercapacitor units 108, which continuously supply electric charge to the electric vehicle 102.

The base module 122 may further include a health and safety module 136. The health and safety module 136 may be configured to provide health and safety-related information to the user, e.g., information related to the safety of the battery (danger of fire or explosion) of the electric vehicle 102. For example, if the electric vehicle 102 experiences some health-related problems, such as batteries getting near an over-temperature situation, this will be displayed using the display interface 114.

The electric vehicle 102 may be further provided with a security module 138 to continuously measure the plurality of supercapacitor units 108 installed within the electric vehicle 102. The security module 138 may also evaluate and warn users how external charging hookups may be configured.

The base module 122 may include a motor control module 140 to enhance the performance of the vehicle motor of the electric vehicle 102. In one embodiment, the motor control module 140 may be configured to evaluate the performance of the vehicle motor in at least two modes. In one embodiment, the two modes may be an enhanced torque mode and an economy mode. The enhanced torque mode may be employed when the electric vehicle 102 moves up a hill or the steep curve of the road upwards. The motor consumes more electric charge to generate more torque for moving the electric vehicle 102 upwards. Further, the economy mode may be initiated when the electric vehicle 102 moves downhill. Less electric charge is needed to drive the electric vehicle 102 downwards. In one embodiment, the motor control module 140 may be configured to monitor and anticipate the performance of the electric motor according to the enhanced torque mode or the economy mode. Further, the motor control module 140 may retrieve data related to parameters affecting the movement of the electric vehicle 102 over the path from the energy management database 104 and the design database 120. In one embodiment, the data may include, but is not limited to, GPS data, weather, length of the day, length of a golf course, etc.

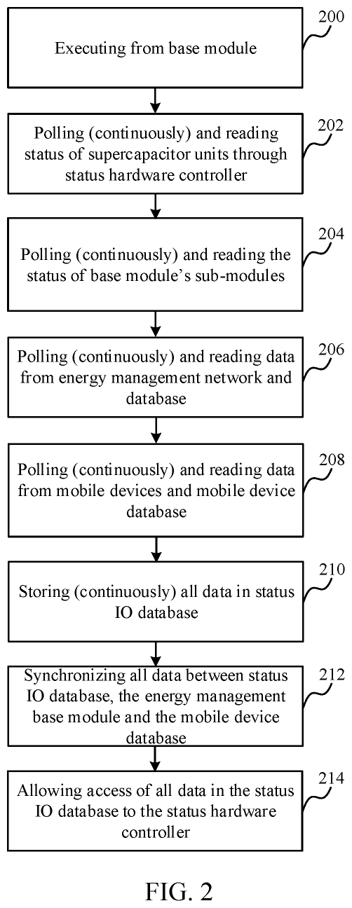

The base module 122 may further include a status IO control module 142 that controls and sends status for a status IO controller. The status IO control module 142 is described in greater detail with respect to FIG. 2.

A communication interface 144 (shown as “COMM 144” in FIG. 1B) may provide a communication path between the electric vehicle 102, the cloud 106, and a plurality of mobile devices 1-N (designated herein as mobile devices 148, when used collectively, and mobile device 148, when used individually). The communication interface 144 may include hardware and software that implement a plurality of communication types, such as, without limitation, WiFi, Zigbee, Bluetooth, cellular, etc.

A status hardware controller 146 connects the supercapacitor units 108, the communication interface 144, and the status IO control module 142 of the base module 122.

The mobile devices 148 may include a variety of mobile devices, such as, without limitation, smartphones, tablets, PCs, etc. A mobile communication interface 150 (shown as “MOBILE COMM 150” in FIG. 1B) allows for communication from the mobile devices 148 to either the cloud 106 or the communication interface 144. The mobile communication interface 150 may include hardware and software that implement a plurality of communication types, such as, without limitation, WiFi, Zigbee, Bluetooth, cellular, etc. The mobile devices 148 include electronics 152 that comprise all the hardware and software needed for the mobile devices 148 to operate. Each mobile device 148 may also include a display 154 (which may be touch sensitive) that allows the user of the mobile device to interact with the other mobile devices 148 or other elements of the system 100. Each mobile device 148 may further include a mobile device base module 156 (shown as “MD Base Module 156” in FIG. 1B) that controls the mobile device 156. The mobile device base module 156 may include a geographic module 160 (shown as “Geo Module 160” in FIG. 1B) that allows for a map application to be made available on the display 154 of the mobile devices 148. Further, the mobile devices 148 may each include, or have access to, a mobile device database 158 (shown as “MD Database 158” in FIG. 1B) that allows for storage or extracting any data related to the mobile devices 148.

FIG. 2 is a flowchart of a method performed by the status IO control module 142 shown in FIG. 1B. The process begins at step 200 with executing the status IO control module 142 from the base module 122. In one embodiment, the base module 122 controls all of its sub-modules, including the status IO control module 142, based upon either logical progression through the sub-modules or by events or interrupts. For example, the status IO control module 142 may be executed in sequence or from interrupts from the status hardware controller 146. In one embodiment, the function of the status IO control module 142 is to receive and store all information via polling of all the sub-modules of the base module 122, all the data in the energy management base module database 162 (shown as “EM BASE MODULE DATABASE 162” in FIG. 1B), and all the data in the mobile device database 158, all through the status hardware controller 146 and its connection to the communication interface 144. The status IO control module 142 also allows a status IO database 164 to provide data to the status hardware controller 146. The process synchronizes all data between a status IO database 164, an energy management base module database 162, and the mobile device database 158.

At step 202, the status IO control module 142 polls (e.g., continuously) and reads the status of the supercapacitor units 108 through the status hardware controller 146. This data, for example, may include the current voltage, the configuration of the supercapacitors as defined in the crossbar switch matrix, the discharge percentage, the temperature, etc.

At step 204, the status IO control module 142 polls (e.g., continuously) and then reads the status of the sub-modules of the base module 122. This data, for example, may include any data related to the energy optimization module 124, the charging module 126, the maintenance module 128, the speed optimization module 130, the control module 132, the communication module 134, the health and safety module 136, the security module 138, and the motor control module 140.

At step 206, the status IO control module 142 polls (e.g., continuously) and reads data from the energy management database 104. This data, for example, is any data related to third party applications pertaining to the sub-modules of the base module 122. For instance, it may contain information related to energy optimization, charging, maintenance, speed optimization, control, communications, health and safety, security, and motor control, etc.

At step 208, the status IO control module 142 polls (continuously) and reads data from mobile device database 158 of each mobile device 148. This data, for example, may include any data related to mobile device applications that pertain to the sub-modules of the base module 122. For instance, it may contain information related to energy optimization, charging, maintenance, speed optimization, control, communications, health and safety, security, and motor control data.

At step 210, the status IO control module 142 stores all data in the status IO database 164.

At step 212, the status IO control module 142 synchronizes all data between the status IO database 164, the energy management base module database 162, and the mobile device database 158 of each mobile device 148. This synchronized data, for example, is any data related to mobile device applications that relate to the sub-modules of the base module 122. For instance, the data may relate to energy optimization, charging, maintenance, speed optimization, control, communications, health and safety, security, and motor control data. For example, synchronization updates the status IO database 164, the energy management base module database 162, and the mobile device database 158 with all current information available or that can be synchronized by profile selections, such as the “safest speed control” or the “longest battery life” or the “fastest charging time” etc.

At step 214, the status IO control module 142 allows access to all data in the status IO database 164 to the status hardware controller 146. For example, all of the data to control the electric vehicle 102 can come from the status IO database 164 of the electric vehicle 102. In some embodiments, all of the data to control the electric vehicle 102 can come from the energy management base module database 162. In some embodiments, all of the data to control the electric vehicle 102 can come from the mobile device database(s) 158. This allows the mobile devices 148 to control the electric vehicle 102 directly. In some embodiments, the data to control the electric vehicle 102 can come from a hybrid of the mobile device database(s) 158, the energy management base module database 162, and the status IO database 164.

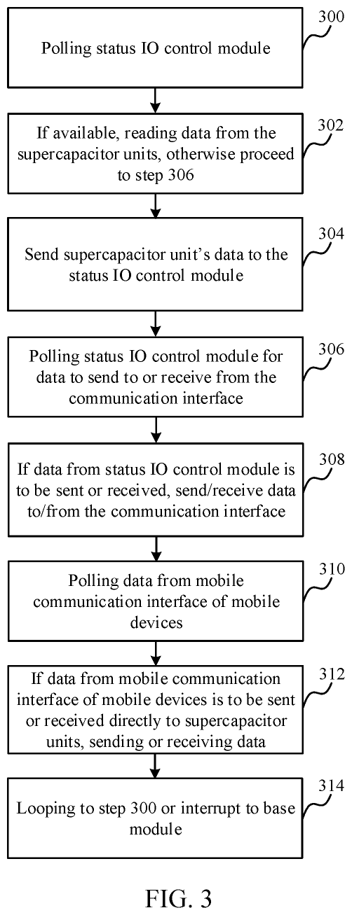

FIG. 3 is a flowchart of a method performed by the status hardware controller 146 shown in FIG. 1B. At step 300, the status hardware controller 146 polls the status IO control module 142. If data is available, the status hardware controller 146 reads the data from the supercapacitor unit 108 in step 302 and sends the data regarding the supercapacitor unit 108 to the status IO control module 142 at step 304.

At step 306, the status hardware controller 146 polls the status IO control module 142 for data to be sent to or received from the communication interface 144. If data from the status IO control module 142 is to be sent or received, the status hardware controller 146 sends/receives data to/from the communication interface 144 at step 308.

At step 310, the status hardware controller 146 polls data from the mobile communication interface 150 of the mobile devices 148. If data from the mobile communication interface 150 of the mobile devices 148 is to be sent or received directly to the supercapacitor 108 units, the status hardware controller 146 sends or receives the data at step 312. At step 314, control loops to step 300 or interrupts to the base module 122.

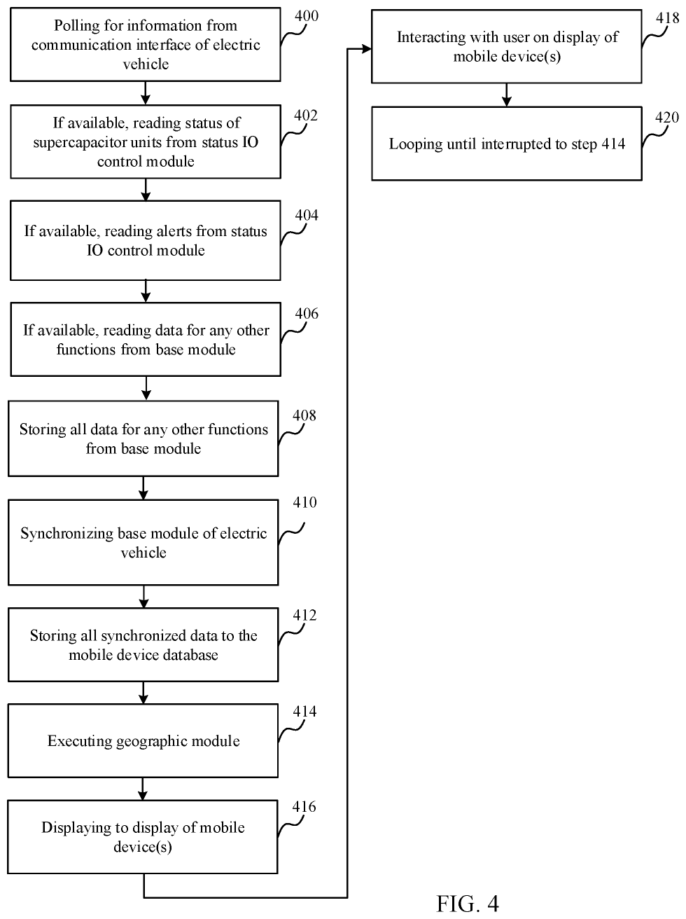

FIG. 4 is a flowchart of a method performed by the mobile device base module 156 shown in FIG. 1B. At step 400, the mobile device base module 156 polls for information from the communication interface 144 of the electric vehicle 102. If available, the mobile device base module 156 reads the status of the electric vehicle 102 and supercapacitor units 108 from the status IO control module 142 at step 402. If available, the mobile device base module 156 also reads any alerts from the status IO control module 142 at step 404. If available, the mobile device base module 156 also reads data for any other functions from the base module 122 at step 406. At step 408, the mobile device base module 156 stores all data for any other functions from the base module 122.

At step 410, the mobile device base module 156 synchronizes the energy management base module database 162 of the energy management database 104. By synchronization, all data in the energy management base module database 162 is current with the mobile devices 148. In one embodiment, the energy module base module database 162, the status IO database 164 of the electric vehicle 102, and the mobile device database 158 share the same structure. In other words, they all have data on energy optimization, charging, maintenance, speed optimization, control, communications, health and safety, security, and motor control. In some embodiments, the data will not be synchronized until this step, as the mobile devices 148 may have downloaded new data from the Internet or a cellular network from the mobile communication interface 150 that allows the mobile devices 148 to control the energy optimization, charging, maintenance, speed optimization, control, communications, health and safety, security and motor control different from the last version of status IO database 164 of the electric vehicle 102. In some embodiments, the data will not be synchronized until this step, as the energy management network database 104 may have been updated with new data from the Internet of other 3rd party networks (not shown). When loaded to the mobile devices 148, this new data allows updated control for any of the electric vehicle 102's features, e.g., energy optimization, charging, maintenance, speed optimization, control, communications, health and safety, security, and motor control, at step 408. The mobile device base module 156 stores all synchronized data in the mobile device database 158 at step 412.

In one embodiment, the mobile device base module 156 executes the geographic module 160 at step 414. The mobile device base module 156 displays to the display 154 of the mobile device(s) 148, at step 416, and facilitates interaction with the user on the mobile device(s) 148, at step 418. At step 420, control loops to step 414 until interrupted.

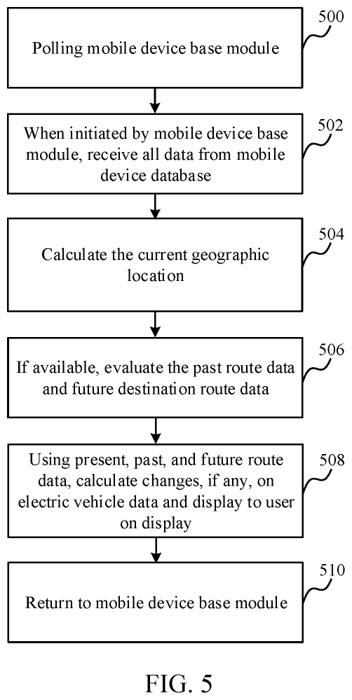

FIG. 5 is a flowchart of a method performed by the geographic module 160 shown in FIG. 1B. At step 500, the geographic module 160 polls the mobile device base module 156. When initiated by mobile device base 156, the geographic module 160 receive all data from mobile device database 158 at step 502. The geographic module 160 then calculates the current geolocation (e.g., GPS coordinates) of the vehicle and/more mobile device 148 at step 504.

If available, the geographic module 160 evaluates past route data and future destination route data. For example, the user may have initiated a map program that integrates with the electric vehicle 102 data to display data related to the future route. At step 508, using present, past, and future route data, the geographic module 160 calculate changes on data for the electric vehicle 102 and displays the same to the user on the display 154. There are countless examples of how data can be calculated and shown to the user in the map program for any of the electric vehicle's data, such as but not limited to, data related to energy optimization, charging, maintenance, speed optimization, control, communications, health and safety, security and motor control. For instance, the route plan could determine the next time to charge or the next time for a maintenance check. In some embodiments, the route plan could provide feedback-based speeds to optimize the supercapacitor units 108. At step 510, control returns to the mobile device base module 156.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other types of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

What is claimed is:

1. A system for evaluating and controlling an electric vehicle including one or more supercapacitors, the system comprising:
a status IO control module configured to:
poll a plurality of modules of the electric vehicle for information, each module controlling one or more of energy optimization, charging, maintenance, speed optimization, control, communications, health and safety, security and motor control of the electric vehicle; and
store information received from the polling of the plurality of modules in a status IO database within the electric vehicle; and
a mobile device configured to access the status IO database via a communication interface and use the stored information in the status IO database to directly control the electric vehicle.

2. The system of claim 1, further comprising:
an energy management database accessible via an energy management network; and
a mobile device database within the mobile device;
wherein the status IO control module is further configured to synchronize the status IO database, the energy management database, and the mobile device database.

3. The system of claim 2, wherein the mobile device is configured to evaluate or control the electric vehicle directly after synchronization of the status IO database, the energy management database, and the mobile device database.

4. The system of claim 2, wherein the mobile device is configured to control the one or more supercapacitors.

5. The system of claim 2, wherein the energy management database is configured to provide historical data related to the electric vehicle.

6. The system of claim 2, wherein the energy management database stores one or more of information related to supercapacitors, electric charge percentage, acceleration of an electric motor, data for individual drivers, driving conditions, power pack identity or characteristics, mass of the electric vehicle including passengers and cargo.

7. The system of claim 2, wherein the energy management database, mobile device database, and status IO database have a similar structure.

8. The system of claim 7, wherein the energy management database, mobile device database, and status IO database each store data received from the plurality of modules of the electric vehicle regarding one or more of energy optimization, charging, maintenance, speed optimization, control, communications, health and safety, security and motor control of the electric vehicle.

9. The system of claim 2, further comprising a mobile device base module configured to:
poll for data from the communication interface;
if data is available, read from the communication interface a status of the electric vehicle and the one or more supercapacitors via the status IO control module; and
storing any data received in a mobile device database within the mobile device.

10. The system of claim 9, wherein the mobile device base module is further configured to:
synchronize the energy management database with the mobile device database.

11. The system of claim 1, wherein the status IO control module connects to the one or more supercapacitors via a status hardware controller.

12. The system of claim 11, wherein the mobile device connects with the status IO control module via the communication interface and the status hardware controller.

13. The system of claim 1, wherein further comprising a status hardware controller configured to:
poll the status IO control module; and
if data is available from the one or more supercapacitors, reading the data from the one or more supercapacitors and sending the data to the status IO control module.

14. The system of claim 11, wherein the status hardware controller is further configured to:
if data is to be sent to or received from the communication interface, sending data to the communication interface or receiving data from the communication interface.

15. The system of claim 14, wherein the status hardware controller is further configured to:
poll for data from a mobile communication interface of the mobile device; and
if data from the mobile communication interface is available to send or receive to the one or more supercapacitors, send the data to the one or more supercapacitors or receive the data from the one or more supercapacitors.

16. The system of claim 1, wherein the plurality of modules are sub-modules of a base module within memory unit of the electric vehicle.

17. The system of claim 1, further comprising a geographic module configured to:
geolocate the electric vehicle; and
evaluate one or more of past route data and future route data.

18. The system of claim 17, wherein the geographic module is further configured to initiate a mapping system that integrates with data received from electric vehicle to display data related to a future route.

19. The system of claim 17, wherein the geographic module is further configured to use present, past, and future route data to calculate changes on data for the electric vehicle and display the changes on a display device.
